(19) United States
(12) Patent Application Publication
(10) Pub. No.: US 2004/0196821 A1
(43) Pub. Date: Oct. 7, 2004

(54) Managing use of services in wireless networks

(76) Inventors: Wassim Haddad, Verdun Municipaitty (CA); James Thomas Edward McDonnell, Charlton Park (GB)

Correspondence Address: LOWE HAUPTMAN GILMAN AND BERNER, LLP, 1700 DIAGONAL ROAD, SUITE 300 /310, ALEXANDRIA, VA, 22314, US

(21) Appl. No.: 10/698,029

(22) Filed: Oct. 31, 2003

(30) Foreign Application Priority Data
Apr. 5, 2003 (GB) 0307916.7

(51) Int. Cl. H04J 3/24; H04L 12/66

(52) U.S. Cl. 370/349; 370/352

(57) ABSTRACT

A mobile user in a foreign wireless network registers via a foreign server, which communicates with a home server in the user's home network to exchange data pertaining to use of a service by the user. The data are in a Session Initiation Protocol (SIP) MESSAGE in accordance with the SIP. In one embodiment, the foreign network holds data indicating use of a service or services in the foreign network by the mobile user, and sends to the home server a SIP MESSAGE including data for the home network to use for billing. In another embodiment, the home network holds account details relating to the use of the foreign network by the mobile user. In response to a SIP MESSAGE from the foreign server identifying the mobile user and the service or services requested by the mobile user, the home server sends to the foreign server a SIP MESSAGE including data indicating permitted use of the foreign network by the mobile user. The foreign server uses the SIP message to control access by the mobile user to a specific service or a number of identified services in the foreign network.

### TECHNICAL FIELD

This invention relates to a method and apparatus for managing use of services by a mobile user in foreign wireless networks.

Potentially, a mobile user registered in a home network would have to open an account with each foreign wireless network it intends to use in order that its use of the foreign network can be billed. However, with the advent of local wireless networks, known as “hot spots”, offering specific services such as high rate internet access or access to games software or local information services, there is likely to be a rapidly increasing number of such networks, with the prospect of a mobile user having to open separate accounts with many that they wish to use.

Accordingly, it is an object of the present invention to provide an improved way of managing mobile users access to and billing for the use of hot spots without having to open a new account with each.

### DISCLOSURE OF THE INVENTION

According to a first aspect, the invention comprises in a method of managing use of a service by a mobile user in a foreign wireless network in which the user registers via a foreign server.

According to a second aspect, the invention comprises in a method of managing use of a service by a mobile user in a foreign wireless network in which the user registers via a foreign server in the foreign network and the foreign server sends to a home server in the user's home network, data of use of said service by said user, said data being incorporated in a message in accordance with the Session Initiation Protocol (SIP MESSAGE).

According to a third aspect, the invention comprises in a server programmed for use in one wireless network to manage use of a service by a mobile user visiting said one network from a home network of the mobile use, the server being programmed to respond to a request for access to a service by a mobile user by sending to a home server in said user's home network, a message containing data identifying the mobile user and the service requested by the mobile user, said message being a first SIP MESSAGE in accordance with the Session Initiation Protocol (SIP).

According to a fourth aspect, the invention comprises in a server programmed for use in one wireless network to manage use of a service by a mobile user visiting said one network from a home network of the mobile use, the server being programmed to communicate with a home server in said user's home network so that the foreign server sends data of use of said service by said user to said home server, said data being incorporated in a message using the Session Initiation Protocol (SIP)

According to yet other aspects, the invention comprises a memory storing in a computer program for managing use of a service by a mobile user in a foreign wireless network accordance with the methods of the first and second aspect of the invention.

A mobile user in a foreign wireless network registers via a foreign server, which communicates with a home server in the user's home network to exchange data pertaining to use of a service by said user, said data being incorporated in a SIP MESSAGE in accordance with the Session Initiation Protocol (SIP). In one embodiment of the invention, the home network holds account details relating to the use of the foreign network by the mobile user, and the home server sends a SIP MESSAGE to the foreign server containing data of permitted use of the foreign network by the mobile user, for the foreign server to use in controlling access by the mobile user to a specific service or any of a number of identified services in the foreign network. The SIP MESSAGE from the home server may be responsive to a SIP MESSAGE from the foreign server identifying the mobile user and possibly the service or services requested by the mobile user. Alternatively or additionally, the foreign network holds data of use of a service or services in the foreign network by the mobile user, and sends a SIP MESSAGE to the home server containing said data for the home network to use for billing purposes.

### DESCRIPTION OF THE DRAWINGS

FIG. 1 shows the layered structure of a wireless network which incorporates SIP packet;

FIG. 2 shows a basic SIP wireless network;

FIG. 3 shows the steps performed during DHCP configuration of a mobile device in a network;

FIG. 4 shows the steps performed during SIP registration of a mobile device in its home network;

FIG. 5 shows the steps performed during SIP registration of a mobile device in a foreign network;

FIG. 6 shows a simple SIP communication; and

FIG. 7 shows an embodiment of the invention in which SIP servers in different wireless networks communicate to exchange data relating to the use of services by a mobile device.

### DESCRIPTION OF THE INVENTION

The Session Initiation Protocol (SIP) has emerged as a new internet-style protocol, and new communication standards, such as 3G, incorporate SIP.

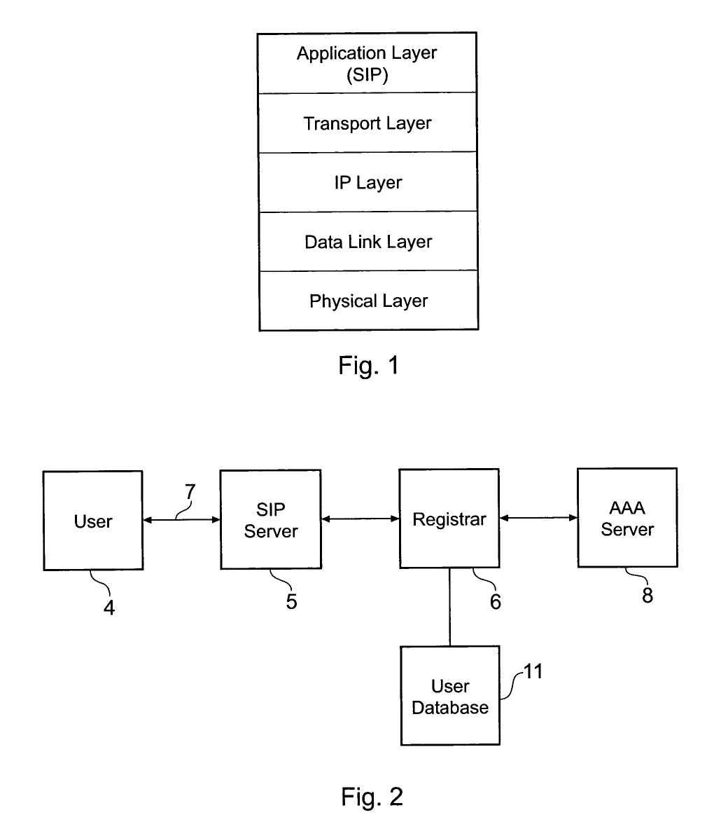

SIP works at the application level of a communication system, as represented in the layer diagram FIG. 1, which shows the SIP communication at a higher level than Internet Protocol (IP) communications.

Communication with SIP involves sending packets of information. The header of each packet includes fields indicating packet type, originator, destination, and length of content in the body. In particular, the header contains three fields essential for addressing, namely a “From:” field, a “To:” field and a “Contact:” field. The “From:” field contains the unique SIP address of a mobile device, for example, alice@home.com. The use of the “To:” field will be described below. The “Contact:” field contains the IP address allocated to the mobile device. The body of some packet types may contain data or a message. Packets having a body containing a message are called SIP MESSAGE packets and they can support instant messaging. Other SIP packet types include SIP REGISTER packets and SIP INVITE packets described further below.

As with mobile networks currently in use, SIP-based networks allow a user to roam to other networks, known as foreign networks, depending on authorisation by the home network. Thus, when a roaming user tries to register with a foreign network, the foreign network must communicate with the home network to query whether it should allow the roaming user to register and whether it should provide mobile services. Thus, the foreign network will only allow registration if the home network has given authorisation. Authorisation is conventionally controlled by Authentication Authorisation and Accounting (AAA) servers.

A user's mobile device has associated with it a unique SIP address, which takes the same form as an e-mail address, for example, alice@home.com. In this example, the domain home.com is the name of the mobile device's home network, and is the network with which the mobile user has an account.

A basic SIP mobile wireless network implementation is shown in FIG. 2. A user's mobile device 4 communicates over a wireless link 7 with a local SIP server 5. The SIP server 5 is connected in a local network with a registrar 6 and an Authentication, Authorisation and Accounting (AAA) server 8. The SIP server 5 uses SIP communications in communicating with the registrar 6 and other SIP servers in other networks via the internet. The registrar 6 communicates with the AAA server 8, and the AAA server 8 communicates with other AAA servers in other networks, using a protocol, such as DIAMETER. The registrar 6 maintains a database 11 of registered mobile devices and their IP and corresponding SIP addresses.

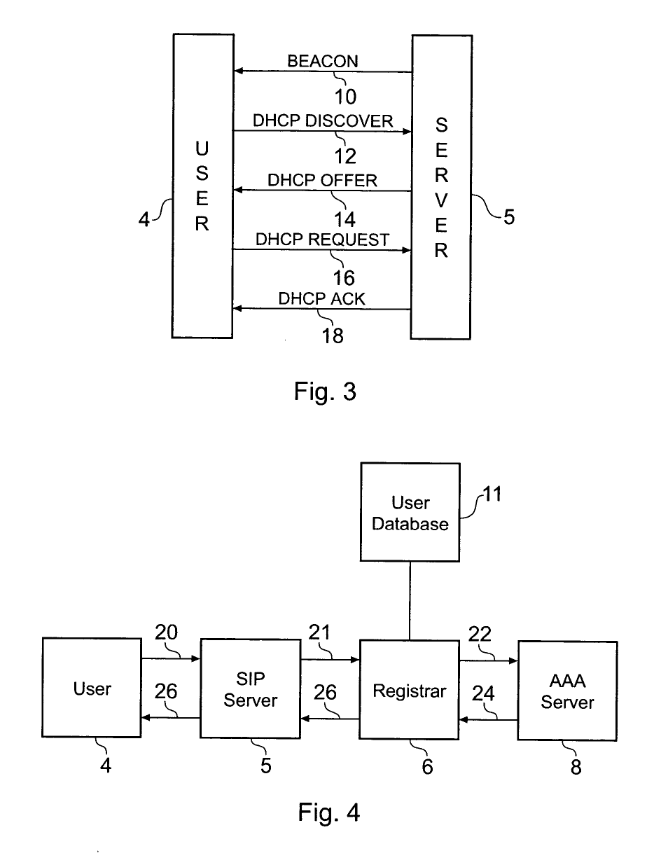

When the mobile device 4 is switched on within its home network, it is first allocated an IP address by a SIP server using Dynamic Host Configuration Protocol (DHCP). The steps for determining the server and IP address are shown in FIG. 3. A periodic radio beacon 10 is broadcast by the SIP server 5, and this is detected by the mobile device 4. The mobile device 4 then broadcasts a DHCP DISCOVER request 12. This request is received by one or more servers 5, depending on the number of servers servicing the area where the mobile device is located. Each server that receives the DISCOVER request sends to the mobile device 4 a DHCP OFFER request 14 offering an IP address to the mobile device 4. The mobile device 4 receives these offers and selects a server, and therefore an IP address that it will use, by sending a DHCP REQUEST 16 to the selected SIP server 5. The SIP server 5 then sends a DHCP ACK acknowledgement 18 to the mobile device 4. Thus, an IP address is allocated to the mobile device 4 by the SIP server 5.

Once the mobile device 4 has selected a server 5 and an IP address, it sends a SIP REGISTER packet to the SIP server 5 to register with the registrar 6 of the local network, as shown by arrow 20 in FIG. 4. The “From:” field in the header of the SIP REGISTER packet contains the unique SIP address of the mobile device 4, for example, alice@home.com. The “To:” field in the header at registration, is the same as the “From:” field. The “Contact:” field in the header contains the IP address allocated to the mobile device 4. The header also contains data indicating that the packet is a SIP REGISTER packet.

The SIP server 5 forwards the SIP REGISTER packet to the registrar 6, shown by arrow 21 in FIG. 4, and the registrar refers to the “From:” field of the header to determine whether or not the mobile device 4 is in its home network. If it is, the registrar 6 sends a query 22 to the AAA server 8 of the local network. Because, the network is the user's home network, the AAA server 8 already contains the home account details of the mobile device 4, which allows the AAA server to check whether or not the mobile device is authorised to access the network. If it is, then the AAA server 8 returns a positive response 24 to the registrar 6. The registrar 6 then updates the internal database 11 to record the SIP address of the mobile device 4 against the IP address so that both are associated with the same mobile device 4 and the server can forward packets of information to the mobile device using the SIP address. The registrar 6 then sends a SIP confirmation 26 via the SIP server 5 to the mobile device 4 to complete SIP registration.

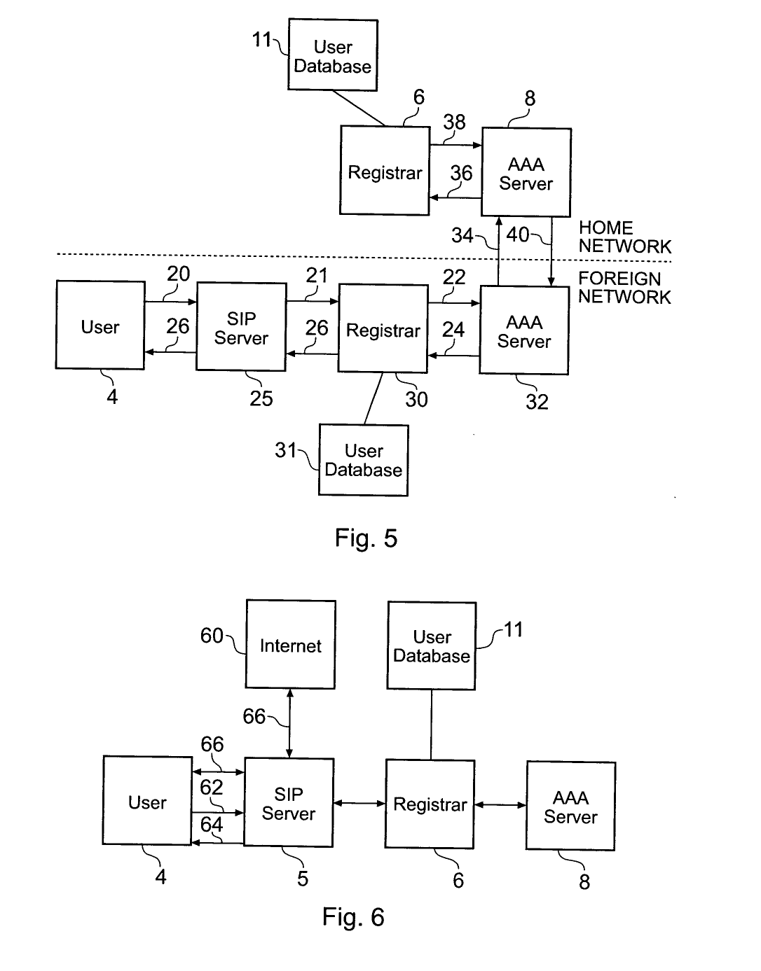

If the mobile device 4 is switched on in a foreign network, or the user of the mobile device roams to a foreign network, then the mobile device 4 acquires a new IP address from a local SIP server using DHCP as described above. However, the SIP registration process is different, and is shown in FIG. 5. In this case, the local SIP server 25 is in a foreign network, for example, foreign.com, and the foreign network includes a foreign registrar 30 and foreign AAA server 32.

The mobile device 4 sends a SIP REGISTER packet, shown by arrow 20, to the foreign SIP server 25, which forwards it, shown by arrow 21, to the foreign registrar 30. The registrar 30 refers to the “From:” field of the packet header to determine whether or not the mobile device is in its home network, and then when it finds it isn't, the foreign registrar 30 assigns a temporary SIP address to the mobile device. The temporary SIP address is an address within the foreign.com domain, and incorporates the logical SIP address. For example, the new SIP address may be alice@home.foreign.com or alice%40home.com@foreign.com, where %40 corresponds to the @ character. The registrar 30 then sends a query 22 to the foreign AAA server 32. The AAA server 32 recognises from the query that the mobile device is not in its home network, and accordingly sends a query to the AAA server 8 of the mobile device's home network, shown by arrow 34 in FIG. 5. The query includes the temporary SIP address assigned to the mobile device 4 in the foreign network.

On receipt of the query 34, the home AAA server 8 recognises from the temporary SIP address that the mobile user is attempting to register in a foreign network. The home AAA server 8 contains account details including data as to whether or not the mobile device 4 is authorised to access the foreign network. If it is, then the AAA server 8 forwards the query to the home registrar 6, shown by arrow 36. The home registrar 6 then updates the internal database 11 to indicate that packets of information destined for alice@home.com should instead be forwarded to the temporary SIP address at foreign.com. Once the database 11 has been updated, the registrar 6 sends a response 38 to the home AAA server 8. The home AAA server 8 then sends a reply 40 to the foreign AAA server 32, which in turn sends a confirmation 24 to the foreign registrar 30. The foreign registrar updates its own internal database 31 so that the temporary SIP address is associated with the allocated IP address of the mobile device 4. The foreign registrar 30 then sends a SIP confirmation 26 to the mobile device 4, via the foreign server 25 so as to complete SIP registration of the mobile device 4 in the foreign network.

If the mobile device 4 is not authorised for registration within the foreign network, then the response 40 sent by the home AAA 8 to the foreign AAA 32 is to refuse the registration. The refusal then propagates through to the mobile device 4, and neither registrar 6 nor registrar 30 updates its user database 11,31.

Once SIP registration is complete, the user can access associated authorised services using SIP communications. An example is shown in FIG. 6, in which a mobile device 4 sets up and utilises a session to surf the internet 60 in its home network. The mobile device 4 first sends a SIP INVITE 62 to the home SIP server 5, which is connected to the internet 60. The SIP INVITE 62 is a SIP packet in which the body of the packet contains data which is formatted according to the Session Description Protocol SDP and identifies media type, media format, session name and other information of the session required. The SIP server forwards the SIP INVITE to the home registrar 6, which queries the home AAA server 8 to determine whether or not internet access as identified in the body of the SIP INVITE is available to the user as identified in the header of the SIP INVITE. If internet access is available to the user then the home AAA server 8 sends a positive response to the registrar 6, which returns a SIP packet 64 to the mobile device 4 indicating that the SIP INVITE is successful. A data link is set up between the mobile device 4 and the internet 60 via the SIP server 5, as shown by arrows 66.

When the mobile device, is in the home network, the network is able to bill the user directly for the use of any service. Also, the user's access may be subject to certain conditions of service as recorded in the home AAA server 6. For example, the user may choose any one or more of voice ability, internet access, MP3 downloading, multimedia streaming and other services. The user may also choose to allocate certain funding levels to different services, or choose other service levels, for example, an offensive content filter for internet access. However, this information about conditions of service is not communicated between the AAA servers, and therefore independent arrangements have been set up in foreign networks to control access by roaming users and to bill roaming users for the services they use.

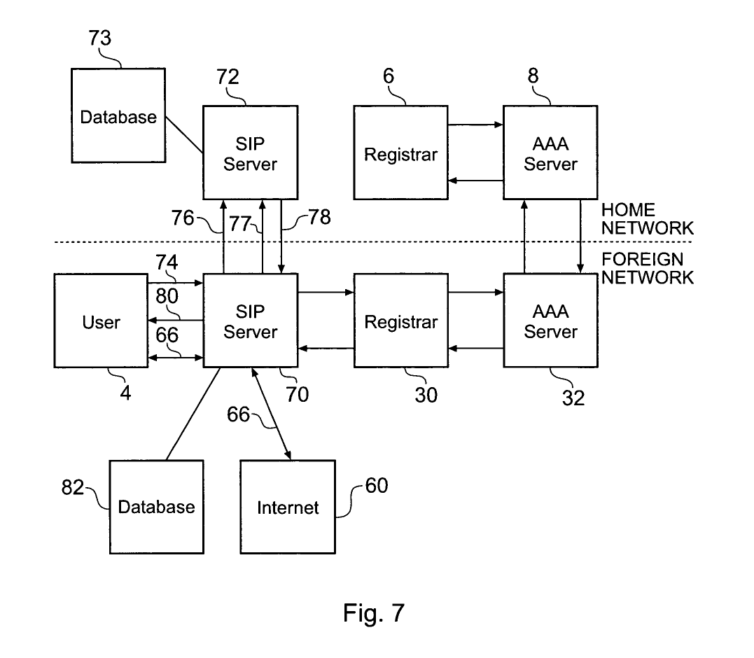

An embodiment of the invention is now described with reference to FIG. 7, in which a mobile device 4 has completed SIP registration in a foreign network after authorisation by the AAA server 8 of the home network, as described hereinbefore. The mobile device 4 communicates via a SIP server 70 in the foreign network, and the SIP server 70 can communicate with a SIP server 72 in the mobile device's home network via the internet using the Session Initiation Protocol SIP. The home SIP server 72 has access to a database 73 which stores account details of the mobile user, for example, credit level, access conditions, available services and the like.

When the user of the mobile device 4 wishes to use a service provided by the foreign network, such as access to the internet 60, the device 4 sends a SIP INVITE 74 to the foreign SIP server 70. The SIP server 70 responds to the SIP INVITE by sending a SIP MESSAGE 76 to the home SIP server 72. The header of the SIP MESSAGE 76 contains “To:” “From:” and “Contact:” fields indicating the address of the SIP server 70 initiating the SIP MESSAGE, and the body of the SIP MESSAGE 76 contains a message comprising account query information. For example, the body of the SIP MESSAGE contains the logical SIP address of the mobile device 4 or other information to identify the device 4, the type of service requested, the amount of service requested, and other relevant information.

Once the home SIP server 72 has received the SIP MESSAGE 76, it extracts the account query information from the body of the packet and consults the database 73 according to the identity of the mobile device 4, and determines whether or not the mobile device 4 is allowed to use the requested service in the foreign network, and whether any conditions need to be imposed. Conditions may include a time limit or a quality of service according to the account details of the user.

The home SIP server 72 then communicates a decision and any conditions back to the foreign SIP server 70 in the body of a SIP MESSAGE 78. The foreign SIP server 70 receives the SIP MESSAGE 78 and extracts the information from the body and determines whether or not to provide the service, and whether to impose conditions on use of the service. In one embodiment, the conditions may specify a time limit for providing the service. Alternatively, the server 70 calculates a time limit using account information, such as credit level details. In either case, the server 70 may send warnings to the mobile device 4 when nearing the end of the time limit, indicating that the service is about to be terminated.

As a further feature, when the mobile device terminates usage of a service, the SIP server 70 sends a SIP MESSAGE 77 to the home SIP server 72 containing details of the usage. These usage details may be held in a local database 82 accessed by the server 70. The home SIP server 72 stores the usage details in a local database, for example, the database 73, so that for billing purposes it maintains a record of all services used by the mobile device 4 in the foreign network.

Alternatively, a registered user is given unconditional access to all services provided by the foreign network, and a SIP MESSAGE 77 containing details of usage is sent from the foreign server 70 to the home server 72 once a provided service has been terminated. Thus, the home network maintains a record of the services used by the mobile device 4 in the foreign network for billing purposes.

It will be appreciated that for each mobile user the database 73 contains, either a single account covering access to services in multiple different foreign networks, or multiple accounts each covering access to services in a respective foreign network or group of foreign networks. The database may also hold all relevant mobile user identification data for each mobile user such as the SIP home address, the SIP foreign temporary address and the foreign IP address.

1. A method of managing use of a service by a mobile user in a foreign wireless network in which the user registers via a foreign server in the foreign network and the foreign server, in response to a request for access to a service by a mobile user, sends to a home server in the user's home network, a message including data identifying the mobile user and the service requested by the mobile user, said message being a first SIP MESSAGE in accordance with the Session Initiation Protocol (SIP).

2. A method as claimed in claim 1, in which the home server responds to the first SIP MESSAGE by sending to the foreign server a second SIP MESSAGE containing data of authorised access by the mobile user to said service, and in which the foreign server refers to said data in said second SIP MESSAGE to control access by the mobile user to said service.

3. A method as claimed in claim 1 in which the home server responds to the first SIP MESSAGE by sending to the foreign server a second SIP MESSAGE including data of all services which the mobile user is authorised to access in the foreign network, and in which the foreign server refers to said data in said second SIP MESSAGE to control access by the mobile user to services.

4. A method as claimed in claim 2 in which account details relating to use of a mobile user in one or more foreign networks is held in a first database in the home network for reference by the home server in generating said second SIP MESSAGE.

5. A method as claimed in claim 2 in which data pertaining to use of said service which a mobile user is authorised to access is held in a second database in the foreign network for reference by the foreign server to control access by said mobile user.

6. A method as claimed in claim 2 in which the foreign server sends data of use of said service by the mobile user to the home server in a third SIP MESSAGE.

7. A method as claimed in claim 6 in which the data of use of said service by the mobile user is held in a database in the foreign network, to which the foreign server refers in sending said third SIP MESSAGE to the home server.

8. A method as claimed in claim 5 in which said second database also holds data for use of said service by the mobile user, and the foreign server refers to the second database in generating a third SIP MESSAGE including data of use of said service by the mobile, the foreign server sending the third SIP MESSAGE to the home server.

9. A method of managing use of a service by a mobile user in a foreign wireless network in which the user registers via a foreign server in the foreign network and the foreign server sends to a home server in the user's home network, data of use of said service by said user, said data being included in a message in accordance with the Session Initiation Protocol (SIP MESSAGE).

10. A method as claimed in claim 9 in which the data of use of said service by the mobile user is held in a database in the foreign network, to which the foreign server refers in sending said SIP MESSAGE to the home server.

11. A method as claimed in claim 9 in which said second database also holds data for control of said service by the mobile user.

12. A server programmed for use in one wireless network to manage use of a service by a mobile user visiting said one network from a home network of the mobile use, the server being programmed to respond to a request for access to a service by a mobile user by sending to a home server in said user's home network, a message containing data identifying the mobile user and the service requested by the mobile user, said message being a first SIP MESSAGE in accordance with the Session Initiation Protocol (SIP).

13. A server as claimed in claim 12 which is arranged to receive a corresponding response from the home server in the form of a second SIP MESSAGE including data of authorised access by the mobile user to said service.

14. A server as claimed in claim 13 which is arranged to control access by the mobile user to said service by reference to data in said second SIP MESSAGE.

15. A server as claimed in claim 14 and a database in which data from said second SIP MESSAGE is held for reference by the server, in controlling access by the mobile user to said service.

16. A server as claimed in claim 12 which is arranged to send data of use of said service by the mobile user to the home server in a third SIP MESSAGE.

17. A server as claimed in claim 15 in which said database also holds data of use of said service by the mobile user, and the server is arranged to refer to the foreign database in generating a third SIP MESSAGE including data of use of said service by the mobile user, the server being arranged for sending the third SIP MESSAGE to the home server.

18. A server programmed for use in one wireless network to manage use of a service by a mobile user visiting said one network from a home network of the mobile use, the server being programmed to communicate with a home server in said user's home network for causing the foreign server to send data of use of said service by said user to said home server, said data being incorporated in a message SIP MESSAGE using the Session Initiation Protocol (SIP)

19. A server programmed for use in one wireless network to manage use of a service by a mobile user visiting a foreign wireless network, the server being programmed to respond to a first message from the foreign network including data identifying said mobile user, by sending to the foreign server a second message including data of authorised access by the mobile user to said server, said first and second messages being included in a message SIP MESSAGE using the Session Initiation Protocol (SIP).

20. A server as claimed in claim 19 in which the second SIP MESSAGE includes data of all services which the mobile user is authorised to access in the foreign network.

21. A server as claimed in claim 19 which is arranged to receive a third SIP MESSAGE from the foreign server including data of use of said service in the foreign network by the mobile user.

22. A server as claimed in claim 21 and a database which holds account details of said mobile user and is arranged to generate said second SIP MESSAGE by reference to said account details.

23. A server as claimed in claim 21 which stores said data in said third SIP MESSAGE in said database.

24. A system for managing use of a service by a mobile user in a foreign wireless network comprising a home server which holds account details relating to use of the mobile user in the foreign network, and a foreign server in the foreign network through which the mobile user registers in the foreign network, the foreign server comprising a server as claimed in claim 12.

25. A system as claimed in claim 24 wherein the home server comprises a server programmed for use in one wireless network to manage use of a service by a mobile user visiting a foreign wireless network, the server being programmed to respond to a first message from the foreign network including data identifying said mobile user, by sending to the foreign server a second message including data of authorised access by the mobile user to said server, said first and second messages being included in a message SIP MESSAGE using the Session Initiation Protocol (SIP).

26. A memory storing a computer program for managing use of a service by a mobile user in a foreign wireless network in which the user registers via a foreign server in the foreign network and the foreign server, in response to a request for access to a service by a mobile user, sends to a home server in the user's home network, a message including data identifying the mobile user and the service requested by the mobile user, said message being a first SIP MESSAGE in accordance with the Session Initiation Protocol (SIP).

27. A memory storing a computer program for managing use of a service by a mobile user in a foreign wireless network in which a method of managing use of a service by a mobile user in a foreign wireless network in which the user registers via a foreign server in the foreign network and the foreign server sends to a home server in the user's home network, data of use of said service by said user, said data being incorporated in a message in accordance with the Session Initiation Protocol (SIP MESSAGE).
